(19) United States
(12) Patent Application Publication
(10) Pub. No.: US 2007/0299967 A1
(43) Pub. Date: Dec. 27, 2007

(54) SYSTEMS AND METHODS TO SELECTIVELY ACQUIRE A DOMAIN NAME REGISTRATION DURING AN ADD GRACE PERIOD

(75) Inventor: Nelson Brady, Vancouver, WA (US)

Correspondence Address: STOEL RIVES LLP, 900 SW FIFTH AVENUE, SUITE 2600, PORTLAND, OR, 97204-1268, US

(73) Assignee: Snapnames.com, Inc., Portland, OR (US)

(21) Appl. No.: 11/765,061

(22) Filed: Jun. 19, 2007

Related U.S. Application Data
(60) Provisional application No. 60/816,190, filed on Jun. 23, 2006.

(51) Int. Cl. G06F 15/173

(52) U.S. Cl. 709/224

(57) ABSTRACT

A method to selectively acquire a domain name registration comprises obtaining a registration for the domain name, and, during an add grace period, collecting traffic data regarding the domain name and determining whether to keep or cancel the domain name based on the collected traffic data. The registration of the domain name may be cancelled based on the collected traffic data falling below a threshold level. The domain name may be kept if the collected traffic data exceeds a threshold during the add grace period. Additionally, one or more domain names may be advertised together with the collected traffic data to receive a response from a third party expressing interest in the domain name.

### RELATED APPLICATIONS

This application claims the benefit under 35 U.S.C. § 119(e) of U.S. Provisional Application No. 60/816,190, filed Jun. 23, 2006, which is hereby incorporated by reference in its entirety.

### COPYRIGHT NOTICE

© 2006 SnapNames.com, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This disclosure relates to evaluating, buying, selling, renting, auctioning and otherwise dealing with internet domain names with regard to their potential business value as distinguished from their technical function merely as network resource locators.

### BACKGROUND INFORMATION

Domain names help Internet users more easily find and communicate with web sites and other server based services by providing a more memorable name that can be resolved into a numeric Internet Protocol (IP) address. For example, if Internet users want to visit the U.S. Patent and Trademark Office's website, they can enter the domain name www.uspto.gov (or the URL http://www.uspto.gov) into their Web browser instead of remembering the IP address 151.207.245.67. However, before a domain name will properly resolve to an IP address, it must first be registered with a domain name registration service.

A domain name registration service (registrar) is responsible for accepting a request for a domain name from an individual or a corporation (i.e., registrant) and determining whether or not the domain name is already in use by someone else. If the domain name is already taken, then the requester must choose a different domain name. If the domain name is available, then the requester is allowed to exclusively use the name and have it registered and stored in a database (registry) that maintains all of the domain names currently registered in the corresponding name space, as further explained below.

Historically, domain name registration has been conducted under a Shared Registration System (“SRS”). The SRS was created by Network Solutions, Inc. in 1999 to provide a registry backend through which multiple, globally diverse registrars could register domain names. The term “registry” refers to the entity responsible for managing allocation of domain names within a particular name space, such as a top level domain (“TLD”). One example of a registry is the VeriSign, Inc. registry for the .com and .net TLDs. The term “registrar” refers to any one of several entities authorized to add names to the registry for a name space. By industry mandate, entities (e.g., companies and end-users) that wish to register a domain name may do so only through a registrar. The term registrant refers to an entity registering a domain name, sometimes also called the owner of the name. More detail can be found in commonly-assigned U.S. Pat. No. 7,039,697, which is hereby incorporated by reference in its entirety.

The specific business arrangements (contracts) between registrars and affiliated registries varies. Some registries require that registrars maintain funds on deposit with the registry (e.g., a “deposit account”). The deposit account is debited automatically each time a registrar submits a command to add a registration to the registry database. In this way, the registrar pays the registry for each domain name registration that is maintained or “sponsored” by that registrar.

In some cases, that debit may be reversed, i.e., the registration fee credited back to the registrar that added the registration, if, within a certain predetermined time period, for example five calendar days after the add command was sent, the registrar cancels the add command. This period is known as an “add grace period.” For example, the registrar might cancel a registration because the registrant changed his mind, or perhaps some mistake was made, such as the spelling of the submitted domain name. The registrar generally has discretion to cancel an add command within the add grace period with or without cause.

Domain names have become important assets for individuals, businesses, and organizations alike. Because they are more intuitive than numeral-based IP addresses, Internet users often type names directly into the name bar of their browser, either navigating directly to an intended site or exploring for information on a concept, perhaps related to the domain name entered in the browser bar.

Not surprisingly, domain names that are short, easy to remember, related to a popular or widely-used concept or idea, and/or are generic (i.e., unrelated to a particular branded or trademarked product or service) are the most coveted, due mainly to their ease of use. These names often receive the greatest rates of “type-in traffic,” referring to the frequency of Internet users entering those domain names into their web browsers and thereby “navigating” to a corresponding resource such as a web site.

Not all domain names resolve, however, to a conventional web site set up to store and provide information, or to a commerce-based site. Domain name owners may invest in domain names speculatively, buying names believed to be inherently valuable for their type-in value, in other words, for their ability to attract traffic. They then may publish a web page with advertisements and links to products or services related to that domain name, and derive remuneration from user traffic that flows through those links in the form of “pay-per-click” or PPC charges. This activity is sometimes called domain traffic monetization, or simply “domain monetization.” A speculator might take steps to monetize a domain name immediately, or simply maintain the domain name registration for several years, believing that it will increase in value over time.

There are monetization service providers (current examples include DomainSponsor, Google, Yahoo, and many others). They place ads on web pages to which the subject domain name resolves. While many providers match ads to keywords in the domain name, others optimize ad selection to maximize PPC revenue based on advanced algorithms or simply trial and error.

As more businesses and individuals become active on the Internet, the value of domain names will presumably continue to grow. However, there is little or no reliable data available to potential registrants (or investors) regarding the current value of a candidate domain name. Further, because of intense price competition in the market, most registrars sell registrations to end-users for very little margin, on the order of a few dollars. Thus, it is difficult for registrars to capture a share of the true market value of a domain name. If a sponsoring registrar had a reliable predictor of the value of a given domain name, it would be in a better position to obtain appropriate compensation for the corresponding registration. Additionally, investors or speculators would be better equipped to make informed decisions on which names to buy or renew if they had a reliable predictor of the value of a given name in terms of attracting traffic—and hence its potential to generate PPC or other forms of commissions or revenue.

### BRIEF DESCRIPTION OF THE DRAWINGS

FIG. 1 is timeline illustrating registering, testing, and keeping/canceling a domain name during an add grace period according to one embodiment.

FIG. 2 illustrates registering, testing, and/or marketing a domain name during an add grace period according to one or more embodiments.

FIG. 3 illustrates a webpage for marketing a domain name according to one embodiment.

FIG. 4 is a block diagram of a digital processing system that may be used to selectively acquire a domain name according to one embodiment.

FIG. 5 is a diagram of a network of computer systems that facilitate assessing domain names during an add grace period according to one embodiment.

### DETAILED DESCRIPTION

With reference to the above-listed drawings, this section describes particular embodiments and their detailed construction and operation. The embodiments described herein are set forth by way of illustration only. Those skilled in the art will recognize in light of the teachings herein that variations can be made to the embodiments described herein and that other embodiments are possible. No attempt is made to exhaustively catalog all possible embodiments and all possible variations of the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

As one skilled in the art will appreciate in view of the teachings herein, certain embodiments may be capable of achieving certain advantages, including by way of example and not limitation one or more of the following: (1) providing data to potential registrants (or investors) regarding the current value of a candidate domain name; (2) allowing a registrar to capture a share of the true market value of a domain name; (3) providing a predictor of the value of a domain name; (4) allowing investors and/or speculators to make informed decisions on which names to buy or renew; and (5) providing a predictor of the value of a given name in terms of attracting traffic. These and other advantages of various embodiments will be apparent upon reading the following.

According to one embodiment, a registrar or its customer selects a domain name, and the registrar sends an “add command” to the corresponding registry to register the name. The registrar's deposit account, if any, is automatically debited to pay the registry fee. The registrar can then conduct a test to assess the efficacy of the domain name to attract traffic. This may be done within the add grace period. Testing can be done by the customer, the registrar, or through the services of a third party.

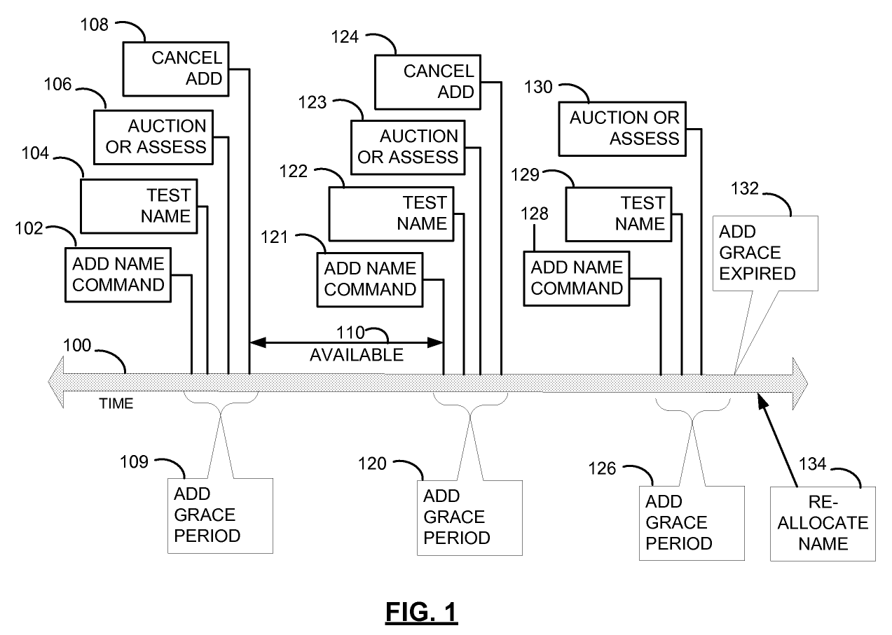

With reference to FIG. 1, a conceptual illustration is provided. In FIG. 1, a timeline 100 conveys the sequence of events, with time marching onward to the right. A registrar can submit an add command 102 to the registry for a selected name. The add command may specify an IP address to which the domain name will resolve—in which case name servers (not shown) are updated accordingly. As will be described in more detail below, the new domain name may be tested 104, mainly to see to what extent it attracts traffic. Based on the test results or metrics, the registrar may decide to keep the name, or alternatively to cancel the add 108, within an add grace period 109 (illustrated below the timeline). Additionally, the registrar may solicit expressions of interest in the name from the public, and/or offer the name at auction 106. If the add is canceled 108, the name becomes generally available for anyone to register (see, e.g., time period 110).

If the name does not attract at least some threshold level of interest or traffic during the test, the registrar may cancel the registration (or cancel the add command), within the add grace period. Accordingly, the registrar is not charged for the registration. If the registrar's deposit account was debited, that sum or at least a portion of it is reversed or credited back to the deposit account, so that the registrar effectively pays little or no money to “test drive” or try out the domain name during the add grace period if the registrar decides not to keep the registration.

A similar sequence of events is shown during an add grace period 120. This sequence of events may reflect a “test drive” of a second domain name, or a second, perhaps modified, test drive of the first domain name. While the add grace period may include a five-day window during which a newly registered domain name may be cancelled for at least a partial refund of the registration fee, the time period may be longer or shorter. Additionally, there may be no refund of the registration fee. A registrar can submit an add command 121 to the registry for a domain name. As described in more detail below, the domain name may be tested 122, such as by collecting traffic data. Based on the test results, the registrar (or third-party) can decide whether to keep or cancel 124 the domain name, within the add grace period 120. Additionally, the domain name may be auctioned 123.

Auctioning the name provides an alternative method for determining its value. The auction may be conducted “with reserve” so that the name will not be transferred to a buyer unless the sum offered for the name exceeds a predetermined threshold amount. In that case, the add can be canceled, again preferably within the add grace period. On the other hand, if interested parties bid up the price during the auction, beyond the threshold amount, the registrar will be compensated for the fair value of the name upon transferring the registration 134 to the winning bidder.

Another similar sequence of events is shown during an add grace period 126. An add command 128 for a domain name may be submitted to the registry and the domain name may be tested 129. This time, the registrar elects to keep the new registration, simply by not canceling the add command 128 during the add grace period 126. Consequently, the add grace period expires 132. The registrar may then re-allocate the new registration 134 to a customer, which may be the winner of an auction 130 of the name.

While the preceding paragraphs speak in terms of the registrar's actions, the registrar may in fact be registering and testing the domain name on behalf of a customer or for its own account. For example, the registrar may select the domain name from a wait list of previously registered domain names that it is maintaining. Additionally, the customer may conduct it's own assessment or testing of the name.

In some embodiments, a registrar may add one or more domain names to the registry, and then publish, for example by email, RSS, or a separate web site (or webpage), a list of those names available within the add grace period. The registrar can invite any and all interested entities (individuals, businesses, etc.) to respond and express their interest in one or more of the domain names. Such indications of interest must be received by the registrar (or its agent) before expiration of the add grace period. If little or no interest is timely received, i.e., before expiration of the add grace period, the registrar has the option to cancel the add, and again, the registrar will have spent little or no money on the trial registration. Because the subject domain name is effectively registered during the add grace period, no other registrar can register, or even test the name, so the described “test drive” is exclusive.

Additionally, if significant interest is shown in one or more domain names, the registrar can auction the name among all those who expressed interest, and then transfer the registration to the winner of the auction. Because the registrar knows that the name will shortly find a paying registrant, the auction itself may extend past the add grace period (e.g., the registrar may keep the domain name by not cancelling it within the add grace period).

Because of the ease and minimal investment required of the registrar, it can apply this process to register, publish or advertise, and then either “throw back” or auction potentially large numbers of domain names, depending on the interest level received.

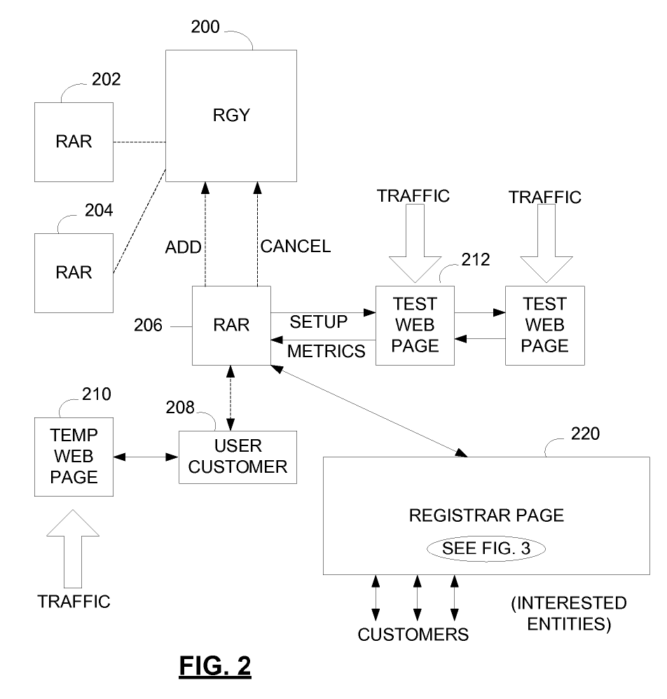

Referring now to FIG. 2, several concepts are described, one or more of which may be included in any embodiment. A registry 200 may have a plurality of affiliated registrars, e.g. registrars 202, 204, and 206. Each of the registrars 202, 204, and 206 can communicate with the registry, as indicated by dashed lines. For example, the registrars 202, 204, and 206 may add, modify, or delete registrations.

The registrar 206 can communicate with a user or customer 208, in any appropriate manner. As previously described, on behalf of the customer 208, or on its own initiative, the registrar 206 can send an add command to the registry 200 to register a name. If the customer 208 requested the registration, it may then setup a temporary web site or webpage 210 for testing the name. The customer, or a third-party service can measure traffic that visits the site. Based on those metrics, the customer may decide to not keep the name, and so inform the registrar, within the add grace period. The registrar can then cancel the name—as discussed with reference to FIG. 1. In one embodiment, the registrar charges a fee to the customer 208 for “test driving” the domain name.

The temporary webpage 210 can include ads, listings or the like that are linked to appropriate commercial web sites that offer goods or services related to the domain name. Metrics are collected during the test period regarding the rate and frequency of visits to the temporary web site established for each domain name. These metrics may provide a good indication of the type-in strength of the domain name, and hence an indication of its revenue-generating potential. Additionally, the metrics may include traffic data at the commercial web site that originated from the temporary webpage 210. For example, if the temporary webpage 210 was for the domain name www.patents.com, the temporary webpage 210 may include a link to www.uspto.gov (or its appropriate numerical IP address). The metrics, such as the number of visits to www.uspto.gov from www.patents.com, could be collected at the server to which www.uspto.gov resolves, such as by capturing the IP address of the visitor.

According to another embodiment, the metrics include a number of queries made to a DNS server for resolving an IP address for the domain name. For example, a DNS server could count the number times it resolves the domain name www.patents.com. According to still another embodiment, the metrics include a number of clicks on a sponsored link to the temporary webpage. For example, the sponsored link, such as a paid advertisement in the form of a hypertext link, may be placed on a search results page, such as www.google.com or www.yahoo.com. The number of clicks on the sponsored link could be counted at the results page or the temporary webpage.

In some embodiments, the registrar may have no pre-existing customer for the name. The registrar may select one or more names, which may be wait-listed if they are already registered. If a selected name is available, the registrar can submit an add command, as previously discussed. The registrar can set up a test web site or webpage 212 and measure traffic attracted by the name. Additionally, metrics may be collected as previously described.

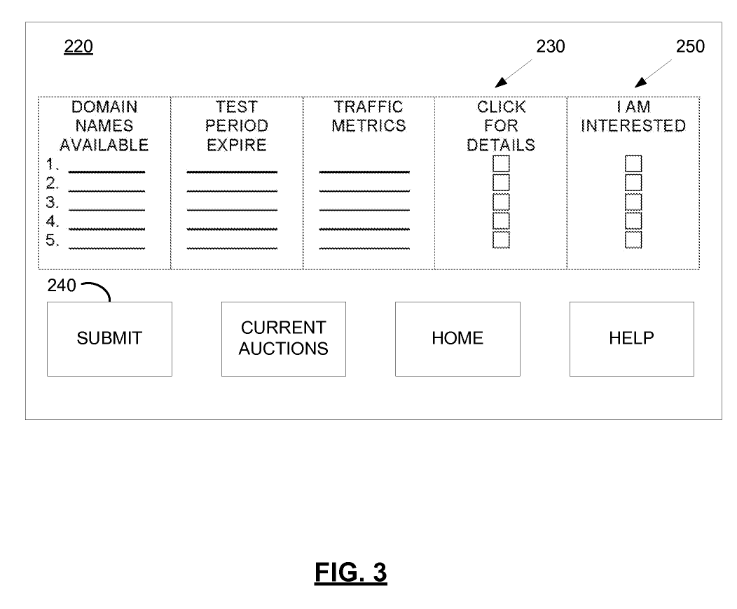

According to still another embodiment, the registrar can host a web site or webpage 220 for marketing the name to potential buyers. Referring now to FIG. 3, one example of a registrar webpage 220 for collecting expressions of interest in a name, and optionally auctioning the corresponding registration, is illustrated. The webpage 220 displays a listing or indication of one or more domain names that the registrar has registered, but for which the add grace period may not yet have expired. The domain names may be undergoing testing, or a test period may have been completed. The site may list an expiration date and time, i.e., a deadline, prior to the end of the corresponding add grace period, for users to express interest in a name. For example, as shown in FIG. 3, a prompt (or link), such as one of the radio buttons 230 entitled “Click For Details,” may be presented to the user so that when the user hits a submit button 240, additional details are sent to the user. Additionally, a prompt, such as one of the radio buttons 250 entitled “I Am Interested,” may be presented to the user so that when the user hits the submit button 240, an expression of interest is sent to the registrar. If few or no expressions of interest are timely received, the registrar can cancel the registration within the add grace period. This process can be entirely automated, i.e. under programmatic control, to reduce costs and ensure timely operation.

If one entity expresses interest in the name, the registrar may offer the registration to that entity. The offering price may be determined based on the test metrics. Or, the user may make an offer. If a deal is struck, the registrar will then re-allocate the registration to the user (presumably after receiving payment). If no deal is struck, the registrar may cancel the add command within the grace period, or simply retain the name in inventory.

If multiple entities express interest in the name, the registrar may auction the registration to the highest bidder. Preferably, the auction is conducted before expiration of the add grace period, so that the registrar can cancel the add if no bid is received above a predetermined minimum or reserve, and the registrar need not pay the registration fee to the registry.

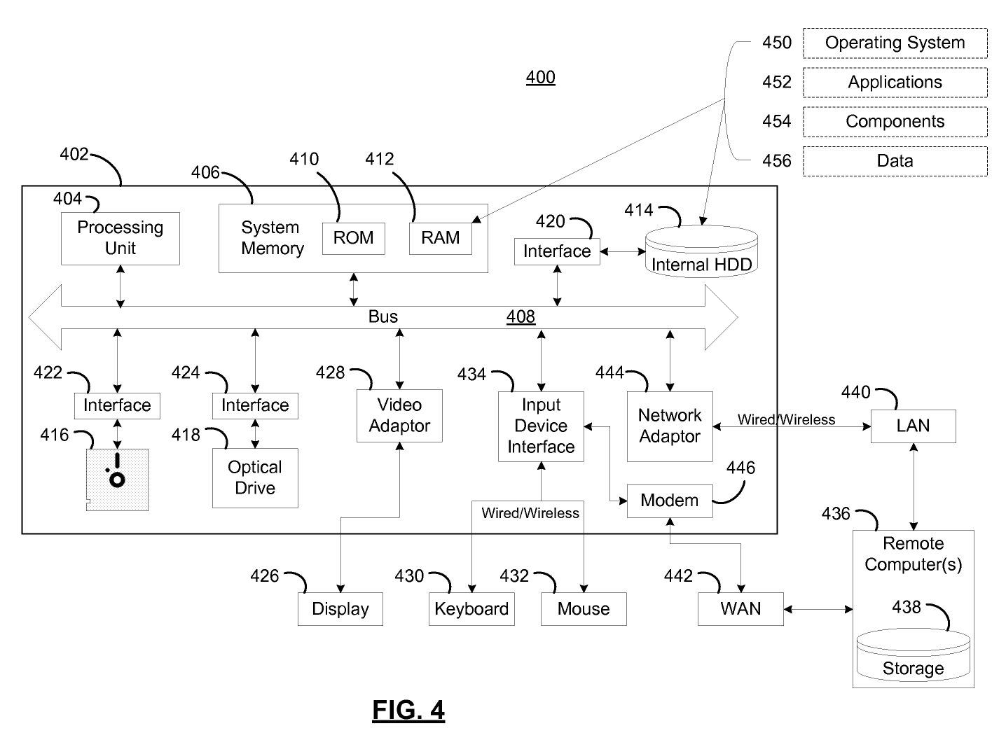

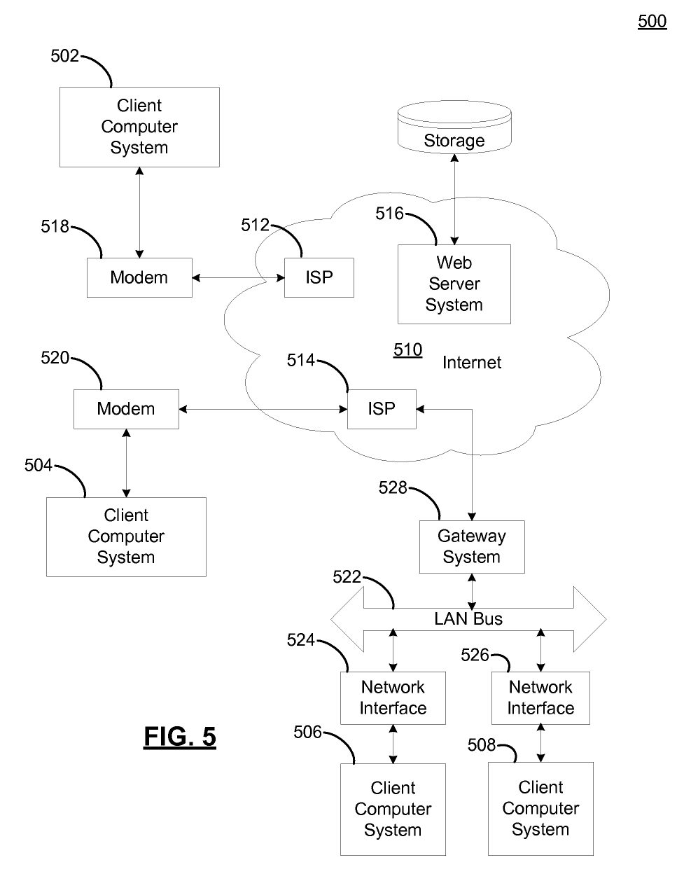

To provide a context for the various aspects of the disclosed subject matter, FIGS. 4 and 5, as well as the following discussion, are intended to provide a brief, general description of a suitable environment in which the various aspects of the disclosed subject matter may be implemented. The methods and systems for selectively acquiring a domain name and for marketing a domain name to potential buyers illustrated and described herein can exist in a variety of forms, both active and inactive. For example, they can exist as one or more software or firmware programs comprised of program instructions in source code, object code, executable code or other formats. As used herein, a software module or component may include any type of computer instruction or computer executable code located within a memory device and/or transmitted as electronic signals over a system bus or wired or wireless network. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Embodiments may include various steps, which may be embodied in machine-executable instructions to be executed by a general-purpose or special-purpose processor (or other electronic device). Alternatively, the steps may be performed by hardware components that include specific logic for performing the steps or by a combination of hardware, software, and/or firmware. A result or output from any step, such as a confirmation that the step has or has not been completed or an output value, may be stored, displayed, printed, and/or transmitted over a wired or wireless network. For example, the metrics collected during the test period regarding the rate and frequency of visits to the temporary web site established for each domain name may be stored or displayed as the metrics are collected. By way of another example, a determination of whether to keep or cancel the registration of the domain name may be stored or transmitted over a network.

Embodiments may also be provided as a computer program product including a machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be via CD-ROM or via Internet download.

With reference to FIG. 4, one possible environment 400 for implementing various aspects of the embodiments includes a computer 402. Computer 402 can be any machine that manipulates data according to a list of instructions. For example, computer 402 may be a mobile device, server, workstation, personal computer, portable computer, microprocessor-based entertainment appliance, peer device, or embedded computer. The computer 402 may include a processing unit 404, a system memory 406, and a system bus 408. The system bus 408 couples system components including, but not limited to, the system memory 406 to the processing unit 404. The processing unit 404 can be any of various commercially available processors. Dual microprocessors and other multi-processor architectures may also be employed as the processing unit 404.

The system memory 406 includes ROM 410 and RAM 412. A basic input/output system (BIOS) may be stored in a non-volatile memory 410 such as ROM, EPROM, EEPROM. The BIOS contains basic routines that help transfer information between elements within the computer 402, such as during the boot-up sequence. The RAM 412 may include a high-speed RAM such as static RAM for caching data.

The computer 402 may include an internal hard disk drive (HDD) 414. The internal HDD 414 may also be configured for external use in a suitable chassis (not shown). The computer 402 may also include a magnetic floppy disk drive (FDD) 416 and an optical disk drive (ODD) 418. The FDD can read from or write to a removable diskette and the ODD 418 can read a CD-ROM disk or read from or write to other high capacity optical media such as a DVD. The HDD 414, FDD 416 and ODD 418 can be connected, respectively, to the system bus 408 by a hard disk drive interface 420, a magnetic disk drive interface 422 and an optical drive interface 424. Any one of the interfaces 420, 422, and 424 may be configured for external drive implementations and include at least one or both of Universal Serial Bus (USB) and IEEE 1194 interface technologies. Other external drive connection technologies are within contemplation of the subject systems and methods.

The computer 402 can present data, prompts, and otherwise communicate with the user via one or more display devices 426. The display devices 426 can be connected to the system bus 408 via an interface, such as a video adapter 428. The user can communicate with the computer 402 via one or more wired/wireless input devices. For example, the user may utilize a keyboard 430 and a pointing device, such as a mouse 432. Additionally, other input devices may include a webcam, microphone, digital camera, fingerprint scanner, image scanner, a joystick, a gamepad, touchscreen, touchpad, trackball, tablet, or the like. These and other input devices may be connected to the processing unit 404 through an input device interface 434 that is coupled to the system bus 408. Additionally, the input devices can be connected by other interfaces, such as a parallel port, an IEEE 1194 serial port, a game port, a USB port, an IR interface, etc.

The computer 402 may operate in a networked environment using logical connections via wired and/or wireless communications to one or more remote computers, such as one or more remote computers 436. The remote computers 436 can be any machine that manipulates data according to a list of instructions. For example, the remote computers 436 may be a mobile device, server, workstation, router, personal computer, portable computer, microprocessor-based entertainment appliance, peer device, embedded computer, or other common network node. The remote computers 436 may include one or more of the elements described with respect to the computer 402. For brevity, only a memory/storage device 438 is illustrated. The logical connections depicted include wired/wireless connectivity to a local area network (LAN) 440, such as a computer network covering a small geographic area (e.g., a home, office, or group of buildings). Additionally, the remote computers 436 may be connected to larger networks, such as a wide area network (WAN) 442.

The LAN 440 and WAN 442 networking environments facilitate communication between computer systems and can include devices separated by a few meters (e.g., Bluetooth™) or nearly unlimited distances (e.g., the Internet). In the case of a wired connection, a data bus may be provided using any protocol, such as Advanced Technology Attachment (ATA), Personal Computer Memory Card International Association (PCMCIA), and/or Universal Serial Bus (USB), for example. The wireless connection may use low powered electromagnetic waves to transmit data using any wireless protocol, such as Bluetooth, WiFi, IEEE 802.11, Infrared Data Association (IrDA), and/or Radio Frequency Identification (RFID), for example.

When used in a LAN networking environment, the computer 402 may be connected to the local network 440 through a wired and/or wireless communication network interface or adapter 444. The adaptor 444 may facilitate wired or wireless communication to the LAN 440, which may also include a wireless access point disposed thereon for communicating with the wireless adaptor 444.

When used in a WAN networking environment, the computer 402 can include a modem 446. Additionally, the computer 402 may be connected to a communications server on the WAN 442 or may have other means for establishing communications over the WAN 442, such as the Internet. The modem 446, which can be internal or external and a wired or wireless device, may be connected to the system bus 408 via the serial port interface 434. In a networked environment, program modules, or portions thereof, can be stored in the system memory 406, HDD 414, or the remote memory/storage device 438. The network connections shown are merely examples and other means of establishing a communications link between the computers can be used.

The drives and their associated computer-readable media provide nonvolatile storage of data, data structures, and computer-executable instructions. The drives and media may accommodate data storage in any suitable format. Although the description of computer-readable media above refers to a HDD, a removable magnetic diskette, and a removable optical media such as a CD or DVD, other types of media which are readable by a computer, such as zip drives, magnetic cassettes, flash memory cards, cartridges, and the like, may also be used.

A number of program modules can be stored in the drives and RAM 412, including an operating system 450, one or more application programs 452, other program modules 454 and program data 456. All or portions of the operating system, applications, modules, and/or data can also be cached in the RAM 412. The systems and methods can be implemented with various commercially available operating systems or combinations of operating systems.

FIG. 5 is a diagram of a sample environment 500 with which the systems and methods described herein can interact. The system 500 includes one or more client computer systems 502, 504, 506, and 508. The client computer systems 502, 504, 506, and 508 can be hardware and/or software (e.g. threads, processes, computing devices).

Access to the Internet 510 may be provided by Internet service providers (ISPs), such as ISP 512 and ISP 514. Access to the Internet may facilitate transfer of information (e.g., data, email, text files, media files, etc.) between two or more digital processing systems, such as the client computer systems 502, 504, 506, and 508 and/or a Web server system 516. For example, one or more of the client computer systems 502, 504, 506, and 508 and/or the Web server 516 may provide data (e.g., an indication of a domain name available for purchase) and prompts (e.g., a prompt to receive a submission of an expression of interest in the domain name) to another one or more of the client computer systems 502, 504, 506, and 508 and/or the Web server 516.

The Web server 516 may include a set of communication protocols that implements a protocol stack on which the Internet and other networks run, such as TCP/IP. Additionally, the Web server 516 may be part of an ISP that provides access to the Internet and/or other network(s) for client computer systems. The client computer systems 502, 504, 506, and 508 may each, with appropriate web browsing software, access data, such as HTML documents (e.g., Web pages), which may be provided by the Web server 516. Such data may include indications of one or more domain names available for purchase and traffic data associated with each domain name.

The ISPs 512 and 514 may provide Internet connectivity to the client computer systems 502 and 504 via modem interfaces 518 and 520. As depicted in FIG. 5, such connectivity may vary between various client computer systems, such as the client computer systems 502, 504, 506, and 508. For example, the client computer system 502 may be coupled to the ISP 512 through the modem interface 518 or could be coupled to the Internet via a LAN. The interfaces 518 and 520 may represent an analog modem, an ISDN modem, a cable modem, a satellite transmission interface (e.g., “Direct PC”), a wireless interface, or other interface for coupling a digital processing system, such as a client computer system, to another digital processing system. The client computer systems 506 and 508 may be coupled to a LAN bus 522 through network interfaces 524 and 526, respectively. The network interfaces 524 and 526 may be an Ethernet-type, Asynchronous Transfer Mode (ATM), or other type of network interface. The LAN bus 522 may also be coupled to a gateway digital processing system 528, which may provide firewall and other Internet-related services for a LAN. The gateway digital processing system 528, in turn, may be coupled to the ISP 514 to provide Internet connectivity to the client computer systems 506 and 508.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

1. A method to selectively acquire a domain name registration, comprising:
obtaining a registration for the domain name;
during an add grace period, collecting traffic data regarding the domain name; and
during the add grace period, determining whether to keep or cancel the domain name registration based on the collected traffic data.

2. The method of claim 1 further comprising:
during the add grace period, cancelling the registration of the domain name if the collected traffic data reflects an amount of traffic that is below a predetermined threshold value thereby releasing the domain name for subsequent registration.

3. The method of claim 1 further comprising:
if the collected traffic data exceeds a predetermined threshold value during the add grace period, keeping the registration of the domain name beyond the add grace period.

4. The method of claim 1 wherein collecting traffic data regarding the domain name includes:
creating a webpage to which the domain name resolves; and
measuring a number of visits to the webpage.

5. The method of claim 1 wherein collecting traffic data regarding the domain name includes:
creating a first webpage to which the domain name resolves, the first webpage having a link to a second webpage; and
measuring a number of visits to the second webpage via the link on the first webpage.

6. The method of claim 1 wherein collecting traffic data regarding the domain name includes measuring a number of queries made to a DNS server for resolving an IP address for the domain name.

7. The method of claim 1 wherein collecting traffic data regarding the domain name includes:
placing a sponsored link for the domain name on a webpage; and
measuring a number of visits to the sponsored link.

8. The method of claim 1 wherein the add grace period includes a predetermined unit of time during which a newly registered domain name may be cancelled for at least a partial refund of a registration fee.

9. The method of claim 1 further comprising:
advertising the domain name for sale together with the collected traffic data.

10. The method of claim 9 wherein the step of advertising includes publishing the domain name and the collected traffic data on a webpage.

11. The method of claim 9 wherein the step of advertising includes sending the domain name together with the collected data to a web feed.

12. The method of claim 1 further comprising:
during the add grace period, auctioning the domain name.

13. The method of claim 1 wherein the domain name is selected from a wait list of previously registered domain names.

14. A machine-readable medium on which are stored computer program instructions for performing the method to selectively acquire the domain name registration according to claim 1.

15. A system for selectively acquiring a domain name registration, comprising:
a domain name registration component for obtaining a registration of the domain name;
a data collection component for collecting traffic data regarding the domain name during an add grace period; and
a domain name qualifier component for determining whether to keep or cancel the domain name registration based on the collected traffic data during the add grace period.

16. The system of claim 15 wherein the domain name registration component, the data collection component, and the domain name qualifier component are implemented in software.

17. The system of claim 15 wherein the domain name qualifier component cancels the registration of the domain name during the add grace period based on the collected traffic data falling below a threshold thereby releasing the domain name for subsequent registration.

18. The system of claim 15 wherein the domain name qualifier component keeps the registration of the domain name if the collected traffic data exceeds a threshold during the add grace period.

19. The system of claim 15 wherein the data collection component includes:
a webpage publication component for publishing a webpage to which the domain name resolves; and
a traffic measuring component for measuring a number of visits to the webpage.

20. The system of claim 15 wherein the data collection component includes:
a webpage publication component for publishing a first webpage to which the domain name resolves, the first webpage having a link to a second webpage; and
a traffic measuring component for measuring a number of visits to the second webpage via the link on the first webpage.

21. The system of claim 15 wherein the data collection component includes a traffic measuring component for measuring a number of queries made to a DNS server for resolving an IP address for the domain name.

22. The system of claim 15 further comprising:
an advertising component for advertising the domain name together with the collected traffic data and for receiving an expression of interest in the domain name from a potential buyer.

23. The system of claim 15 further comprising:
a marketing component for calculating a minimum price for the domain name based on the collected traffic data, soliciting an offer for the domain name from a potential buyer, and transferring the domain name registration to the potential buyer based upon receiving an offer from the potential buyer exceeding the calculated minimum price.

24. The system of claim 15 further comprising:
a marketing component for calculating a minimum price for the domain name based on the collected traffic data, soliciting an offer for the domain name from a potential buyer, and cancelling the domain name registration upon receiving no offer exceeding the calculated minimum price.

25. The system of claim 15 further comprising:
an auctioning component for auctioning the domain name among a plurality of potential buyers based on receiving an expression of interest in the domain name from multiple third parties.

26. A method in a computer system for marketing a domain name to potential buyers, comprising:
presenting an indication of a domain name registration available for purchase to a potential buyer during an add grace period;
presenting to the potential buyer an indication of traffic the domain name attracts based on data collected during the add grace period; and
presenting a prompt to the potential buyer to receive a submission of an expression of interest in the domain name during the add grace period.

27. The method of claim 26 further comprising:
presenting to the potential buyer an indication of a deadline for the potential buyer to submit the expression of interest in the domain name.

28. The method of claim 26 further comprising:
presenting a prompt to the potential buyer to make an offer on the domain name.

29. The method of claim 28 further comprising:
presenting an indication to the potential buyer that the domain name registration will be transferred to the potential buyer based upon the offer exceeding a minimum price for the domain name and the offer exceeding all other offers timely received for the same domain name registration.

30. The method of claim 28 wherein the offer is proportional to a value of the domain name based on the data collected during the add grace period.

31. The method of claim 26 wherein presenting the indication of the domain name available for purchase to the potential buyer and presenting the indication of traffic the domain name attracts to the potential buyer includes publishing the domain name together with the collected traffic data on a webpage.

32. The method of claim 26 wherein presenting the indication of the domain name available for purchase to the potential buyer and presenting the indication of traffic the domain name attracts to the potential buyer includes sending the domain name together with the collected traffic data to a web feed.

33. A machine-readable medium on which are stored computer program instructions for performing the method for marketing a domain name to potential buyers according to claim 26.
